(19) United States
(12) Patent Application Publication
(10) Pub. No.: US 2016/0300147 A1
(43) Pub. Date: Oct. 13, 2016

(54) APPARATUS AND METHOD FOR PREDICTING ELECTRICITY APPLIANCE USAGE

(71) Applicant: Electronics and Telecommunications Research Institute, Daejeon (KR)

(72) Inventors: Jeu Young KIM, Daejeon (KR); Ji Yeon SON, Daejeon (KR); Hark Jin LEE, Daejeon (KR)

(21) Appl. No.: 15/093,978

(22) Filed: Apr. 8, 2016

(30) Foreign Application Priority Data
Apr. 10, 2015 (KR) 10-2015-0051017

(51) Int. Cl. G06N 5/04; H04L 12/28; G05B 15/02

(52) U.S. Cl. CPC G06N 5/047; G05B 15/02; H04L 12/2803

(57) ABSTRACT

Provided herein is a network-based home electronic appliance usage predicting apparatus including an information collecting unit configured to receive electricity usage information of at least one home electronic appliance through a network; an information database configured to store the electricity usage information received by the information collecting unit; and a pattern analyzing unit configured to analyze a usage pattern of a corresponding home electronic appliance based on the electricity usage information stored in the information database, generate information on predicted electricity usage of the home electronic appliance based on a result of the analysis, and store the information on predicted electricity usage of the home electronic appliance in the information database.

### CROSS-REFERENCE TO RELATED APPLICATION

The present application claims priority to Korean patent application number 10-2015-0051017, filed on Apr. 10, 2015, the entire disclosure of which is incorporated herein in its entirety by reference.

### BACKGROUND

1. Field of Invention

Various embodiments of the present disclosure relate to predicting electricity usage, and more particularly, to an apparatus and method capable of analyzing the amount of electricity used in a smart home environment, thereby obtaining a home electronic appliance usage pattern of a user and predicting a future usage pattern.

2. Description of Related Art

In recent days where the concept of smart home based on wired/wireless communication networks is being generalized, users have come to expect more convenient and intelligent services. However, in reality, legacy home electronic appliances still account for most of home electronic appliances, and smart home electronic appliance environments also have problems in that home electronic appliance manufacturers use different communication protocols, and that there is no profile for managing information of home electronic appliance, and therefore, it is difficult to develop integrated and intelligent services.

Conventional systems sense behaviors of users and changes in a home environment through sensors in order to perceive the situation in the home environment or collect operational information of home electronic appliances being transmitted through individual protocols to perceive patterns of the users. The technology of perceiving a home situation through environment sensors is a situation perceiving technology that focuses on the users rather than on the home electronic appliance. The technology of collecting and analyzing operational information of a home electronic appliance through protocols has a disadvantage in that it can only be applied when the home electronic appliance supports those protocols.

Furthermore, most conventional systems analyze comprehensive operational situations inside a home rather than usage patterns of each home electronic appliance, and thus an overall pattern model of the home and a usage pattern model of each home electronic appliance need to be defined and analyzed in different formats.

Furthermore, most conventional systems use technologies of perceiving appliances or statuses of the appliances using a smart grid environment.

### SUMMARY

Therefore, various embodiments of the present disclosure are directed to resolve the aforementioned problems, that is, a purpose of the present disclosure is to analyze the amount of electricity usage of a home electronic appliance so as to understand the status of the home electronic appliance, and to analyze information on the status of the home electronic appliances accumulated based on the usage pattern model of each home electronic appliance, thereby analyzing a home electronic appliance usage pattern that can be used in various smart home services.

According to an embodiment of the present disclosure, there is provided a network-based home electronic appliance usage predicting apparatus including an information collecting unit configured to receive electricity usage information of at least one home electronic appliance through a network; an information database configured to store the electricity usage information received by the information collecting unit; and a pattern analyzing unit configured to analyze a usage pattern of a corresponding home electronic appliance based on the electricity usage information stored in the information database, generate information on predicted electricity usage of the home electronic appliance based on a result of the analysis, and store the information on predicted electricity usage of the home electronic appliance in the information database.

In an embodiment, the network-based home electronic appliance usage predicting apparatus may further include a predicted information providing unit configured to output the information on predicted electricity usage of the home electronic appliance stored in the information database.

In an embodiment, the predicted information providing unit may be a display apparatus.

In an embodiment, the predicted information providing unit may transmit the information on predicted electricity usage of the home electronic appliance to another apparatus.

In an embodiment, the another apparatus to which the information on predicted electricity usage of the home electronic appliance is transmitted may include at least one of a smart phone, desktop computer, notebook, and tablet connected to the network.

In an embodiment, the pattern analyzing unit may include a status clustering module configured to analyze the electricity usage information in a clustering method to generate a status cluster of the home electronic appliance; an information discretizing module configured to convert the electricity usage information that is continuous to discretized electricity usage information; an electricity usage matching module configured to compare the discretized electricity usage information with the status cluster of the home electronic appliance generated in the status clustering module, to determine an actual usage status of the home electronic appliance; and a pattern matching module configured to discover a usage pattern of the home electronic appliance based on data of accumulated results of the determination made by the electricity usage matching module, and convert the discovered usage pattern into data.

In an embodiment, the pattern matching module may include a usage variable generating unit configured to define variables to be applied in order to generate a usage pattern model; a pattern reference generating unit configured to generate a pattern reference to be actually compared according to characteristics of the home electronic appliance based on the usage variable; and a pattern applying unit configured to apply the discretized electricity usage information to the pattern reference.

In an embodiment, the usage pattern reference of the home electronic appliance may include at least one of a date of usage of the home electronic appliance, frequency of usage of the home electronic appliance, and type of usage of the home electronic appliance.

According to another embodiment of the present disclosure, there is provided a network-based home electronic appliance usage predicting method including receiving electricity usage information of at least one home electronic appliance through a network; storing the received electricity usage information in a database; analyzing a usage pattern of a corresponding home electronic appliance based on the stored electricity usage information; and generating information on predicted electricity usage of the home electronic appliance based on a result of the analysis.

In an embodiment, the network-based home electronic appliance usage predicting method may further include storing the generated information on predicted electricity usage in the database, after the information on predicted electricity usage is generated.

In an embodiment, the network-based home electronic appliance usage predicting method may further include outputting the information on predicted electricity usage stored in the database.

In an embodiment, the analyzing a usage pattern of a corresponding home electronic appliance based on the stored electricity usage information may include analyzing the electricity usage information in a clustering method to generate a status cluster of the home electronic appliance; and comparing information on actual electricity usage based on the status cluster of the home electronic appliance.

According to the aforementioned system and method of the present disclosure for predicting usage of a home electronic appliance based on the amount of electricity used, since in the current situation where smart home environments are being widely distributed, infrastructure of a smart grid is being established most rapidly, by providing this apparatus and method for analyzing data of the amount of electricity usage that may be obtained most easily so as to analyze a usage pattern of the home electronic appliance, there is an advantage of perceiving the situation of electronic appliances at home while resolving the difficulty of obtaining information on legacy home electronic appliances and the problem of compatibility of protocols between different manufacturers of home electronic appliances. Furthermore, it is possible to analyze a usage pattern not based on the user but based on each home electronic appliance, thereby providing data that can be used to develop services for each home electronic appliance or to combine home electronic appliances according to intended objectives of a service developer.

### BRIEF DESCRIPTION OF THE DRAWINGS

The above and other features and advantages of the present disclosure will become more apparent to those of ordinary skill in the art by describing in detail embodiments with reference to the attached drawings in which:

FIG. 1 is a view illustrating a home electronic appliance usage predicting apparatus according to an embodiment of the present disclosure, and a home electronic appliance connected thereto;

FIG. 2 is a block diagram illustrating a home electronic appliance usage predicting apparatus according to an embodiment of the present disclosure;

FIG. 3 is a block diagram illustrating a pattern analyzing unit of a home electronic appliance usage predicting apparatus according to an embodiment of the present disclosure;

FIG. 4 is a flowchart illustrating a home electronic appliance usage predicting method according to an embodiment of the present disclosure;

FIG. 5 is a view for explaining a usage pattern model of a home electronic appliance usage predicting apparatus according to an embodiment of the present disclosure;

FIG. 6 is a view illustrating a status cluster of a home electronic appliance generated in a home electronic appliance usage predicting apparatus according to an embodiment of the present disclosure; and

FIGS. 7A and 7B are views illustrating results of electricity usage matching performed based on a status cluster in a home electronic appliance usage predicting apparatus according to an embodiment of the present disclosure.

### DETAILED DESCRIPTION

Hereinafter, embodiments will be described in greater detail with reference to the accompanying drawings. Embodiments are described herein with reference to cross-sectional illustrates that are schematic illustrations of embodiments (and intermediate structures). As such, variations from the shapes of the illustrations as a result, for example, of manufacturing techniques and/or tolerances, are to be predicted. Thus, embodiments should not be construed as limited to the particular shapes of regions illustrated herein but may include deviations in shapes that result, for example, from manufacturing. Like reference numerals in the drawings denote like elements.

Furthermore, ‘connected’ represents that one component is directly connected to another component or indirectly connected through another component.

In this specification, a singular form may include a plural form as long as it is not specifically mentioned. Furthermore, ‘include/comprise’ or ‘including/comprising’ used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

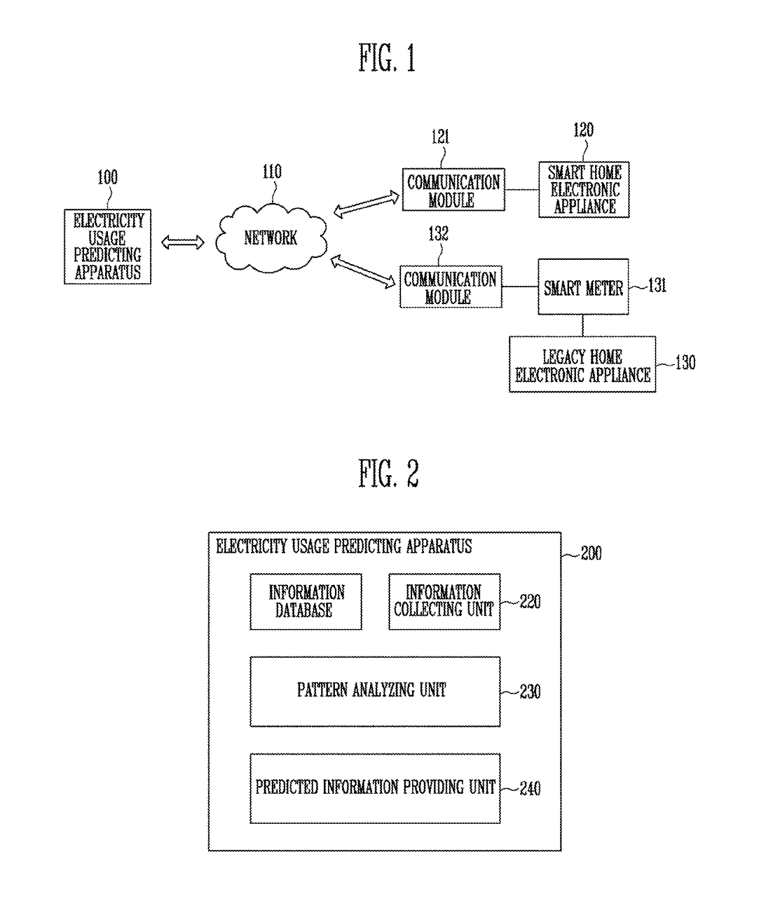

FIG. 1 is a view illustrating a home electronic appliance usage predicting apparatus according to an embodiment of the present disclosure, and a home electronic appliance connected thereto.

Referring to FIG. 1, the home electronic appliance usage predicting apparatus according to an embodiment of the present disclosure 100 is connected to a network 110. Furthermore, at least one home electronic appliance 120, 130 may be connected to the network 110 through communication modules 121, 132, and transmit electricity usage information to the home electronic appliance usage predicting apparatus 100. Herein, a home electronic appliance or smart meter that may be connected to the network 110 may communicate with the home electronic appliance usage predicting apparatus 100, and the home electronic appliance or smart meter may transmit electricity usage information being generated sequentially to the home electronic appliance usage predicting apparatus 100 in real time. The home electronic appliance may be a smart home electronic appliance 120 capable of generating electricity usage information for itself, or a traditional legacy home electronic appliance 130. A legacy home electronic appliance 130 does not include a function of generating electricity usage information or accessing the network 110, and thus an apparatus such as the smart meter 131 may generate the electricity usage information of the legacy home electronic appliance 130 and transmit the electricity usage information to the network 110 through the communication module 132, and finally transmit the electricity usage information to the home electronic appliance usage predicting apparatus 100. In an embodiment, the home electronic appliance usage predicting apparatus according to the present disclosure 100 may periodically collect the electricity usage information of the home electronic appliances 120, 130.

In an embodiment, the network 110 may be the internet, or a home network consisting of a home local network. If the network 110 is a home network, the home network may also be connected to the internet.

The home electronic appliance usage predicting apparatus according to the present disclosure 100 may include an information database that stores electricity usage information of a home electronic appliance received through the network 110. Furthermore, the home electronic appliance usage predicting apparatus 100 may analyze a usage pattern of the home electronic appliances 120, 130 and store a result of the analysis in the information database. Furthermore, a home electronic appliance usage predicting apparatus of the present disclosure is based on the amount of the electricity used in a smart home, and thus a usage pattern model may be defined according to the type or purpose of a home electronic appliance or the purpose of a service. Therefore, the home electronic appliance usage predicting apparatus of the present disclosure may instantly provide a user with a result of usage pattern where a service needed by the user or characteristics of the home electronic appliance have been taken into account.

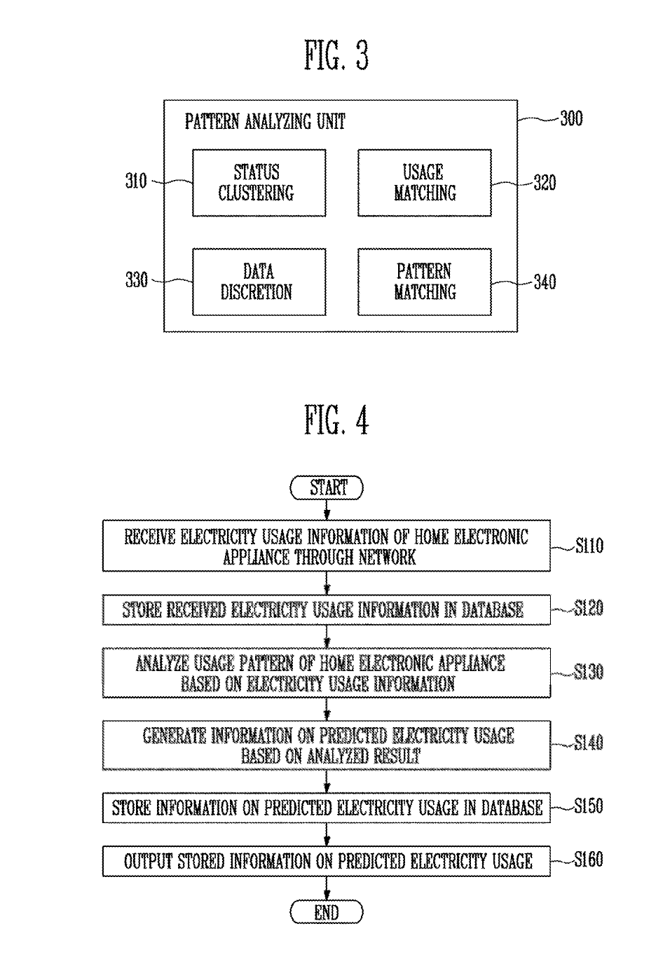

FIG. 2 is a block diagram illustrating a home electronic appliance usage predicting apparatus according to an embodiment of the present disclosure.

Referring to FIG. 2, the home electronic appliance usage apparatus 200 includes an information database 210, information collecting unit 220, pattern analyzing unit 230, and predicted information providing unit 240. The information collecting unit 220 receives electricity usage information of the home electronic appliances connected through the network, and stores the electricity usage information in the information database 210. The information collecting unit 220 may receive the electricity usage information and convert the format of the received electricity usage information into a format suitable for storing in the information database 210. The pattern analyzing unit 230 analyzes a usage pattern of a corresponding home electronic appliance based on the electricity usage information stored in the information database 210. Furthermore, the pattern analyzing unit 230 generates information on predicted electricity usage of the home electronic appliance based on a result of the analysis, and stores the result in the information database 210. The predicted information providing unit 240 outputs the information on predicted electricity usage of the home electronic appliance stored in the information database 210. Herein, the predicted information providing unit 240 may be a display apparatus configured to display the information on predicted electricity usage of the home electronic appliance visually. In another embodiment, the predicted information providing unit 240 may transmit the information on predicted electricity usage of the home electronic appliance to another apparatus. Examples of this another apparatus include at least one of a smart phone, desktop computer, notebook, and tablet. Therefore, from even a remote place, the user may check the information on predicted electricity usage of the home electronic appliance through this another apparatus that is connected to the home electronic appliance usage predicting apparatus 200 through the network.

The home electronic appliance usage predicting apparatus according to the embodiment of the present disclosure 200 receives electricity usage information of a home electronic appliance through the network, and analyzes the electricity usage information in a clustering method to generate information on predicted electricity usage of the home electronic appliance. Clustering of information may refer to a process of dividing the information into several meaningful sub groups. By dividing the information into sub groups through clustering, and then by understanding the characteristics of each sub group, it is possible to analyze the structure of the data, that is, the electricity usage information.

Herein, clusters being generated may differ depending on the function of the home electronic appliance.

FIG. 3 is a block diagram illustrating a pattern analyzing unit of a home electronic appliance usage predicting apparatus according to an embodiment of the present disclosure.

Referring to FIG. 3, the pattern analyzing unit 300 of the home electronic appliance usage predicting apparatus according to an embodiment may include a status clustering module 310, information discretizing module 330, electricity usage matching module 320, and pattern matching module 340.

The status clustering module 310 may analyze the electricity usage information in a clustering method and generate a status cluster of a home electronic appliance. For example, the status clustering module 310 may generate the status cluster of the home electronic appliance based on characteristics such as a time zone in which the electricity was used, a time zone in which electricity of or more than a certain threshold was used, operation mode of the home electronic appliance and the like.

The information discretizing module 330 may convert sequential electricity usage information into discretized electricity usage information. For example, sequential electricity usage information being received in real time may be discretized by time as electricity usage information accumulated in daily units. That is, the entire electricity used in one day may be converted into a single number.

The electricity usage matching module 320 may compare the discretized electricity usage information with the home electronic appliance status cluster generated in the status clustering module, and determine the actual usage status of the home electronic appliance. The pattern matching module 340 may discover a usage pattern of the home electronic appliance based on a data of accumulated results of the determinations made by the electricity usage matching module 320, and convert it into a model based data.

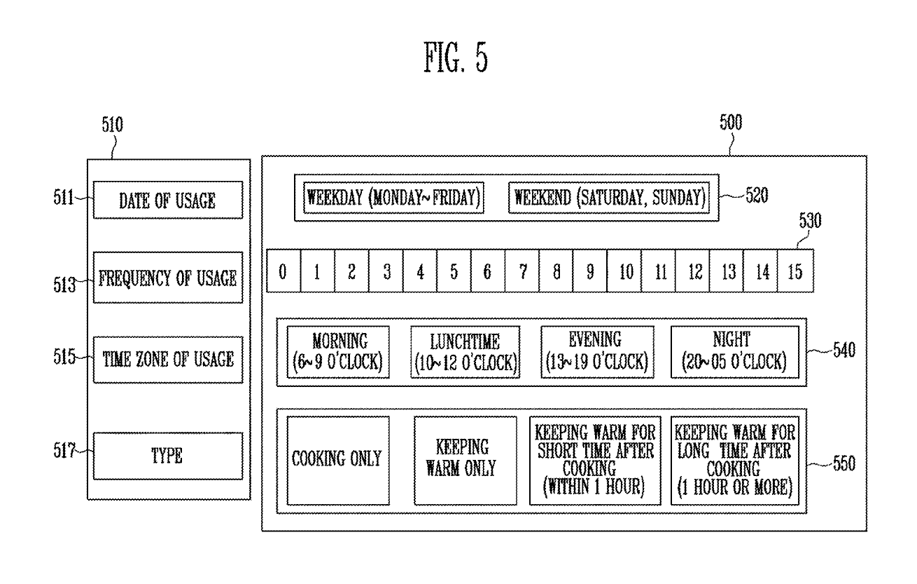

FIG. 4 is a flowchart of a home electronic appliance usage predicting method according to an embodiment of the present disclosure.

Referring to FIG. 4, the home electronic appliance usage predicting method according to an embodiment of the present disclosure includes receiving electricity usage information of at least one home electronic appliance through a network (S110), storing the received electricity usage information in a database (S120), analyzing a usage pattern of the corresponding home electronic appliance based on the stored electricity usage information (S130); generating information on predicted electricity usage of the home electronic appliance based on a result of the analysis (S140); storing the generated information on predicted electricity usage in the database (S150); and outputting the stored information on predicted electricity usage of the home electronic appliance (S160).

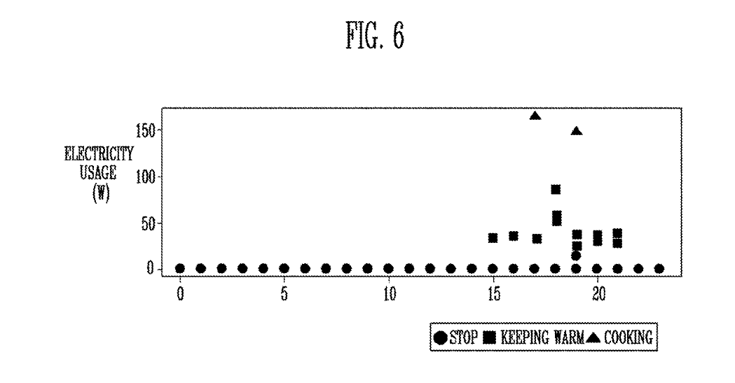

FIG. 5 is a view for explaining a usage pattern model of a home electronic appliance usage predicting apparatus according to an embodiment of the present disclosure.

FIG. 5 illustrates a usage pattern model for an electric rice cooker of home electronic appliances. That is, as illustrated in FIG. 5, the usage pattern model may be defined differently depending on the type and characteristics of the home electronic appliance. As illustrated in FIG. 5, the usage pattern model may include a usage variable 510 and a pattern reference 500 that may be generated based on the usage variable 510.

The usage variable 510 is a component defining the variables to be applied in order to create the usage pattern model. The usage variable 510 includes a date of usage 511, frequency of usage 513, time zone of usage 515, and usage type 517. The pattern reference 500 is a component for modeling the received electricity usage information into meaningful units so that the information may be actually applied. The pattern reference 500 includes an actual usage date reference 520, actual usage frequency reference 530, actual usage time zone reference 540, and actual usage type reference 550. The usage reference 510 and usage reference application area 500 may be changed according to the type of the home electronic appliance and according to the intended type of the information on predicted electricity usage.

Referring to FIG. 5, the pattern reference 500 may be generated based on the usage variable 510. That is, the actual date of usage reference 520 may be generated as weekdays or weekend based on the variable representing the date of usage 511, and the actual frequency corresponding to the usage frequency 513 may be generated as a whole number between 0 to 15 times. Furthermore, the actual usage time zone reference 540 may be generated as morning, lunchtime, evening, or night based on the variable representing the time zone of usage 515, and the actual usage type reference 550 may be generated as “cooking only”, “keeping warm only”, “keeping warm for short time after cooking (within 1 hour)”, or “keeping warm for long time after cooking (1 hour or more)” based on the variable representing the usage type 517. Based on the generated pattern reference 500, the received electricity usage information or discretized electricity usage information may be applied to the corresponding pattern reference 500.

FIG. 6 is a view illustrating a status cluster of a home electronic appliance generated in a home electronic appliance usage predicting apparatus according to an embodiment of the present disclosure.

FIG. 6 illustrates a home electronic appliance status cluster of the corresponding home electronic appliance, i.e. the electric rice cooker by time during one day. Referring to FIG. 6, it can be seen that the electric rice cooker was usually not in operation between 22-14 o'clock, but mainly operated between 15-21 o'clock. Furthermore, between 15-21 o'clock, the electric rice cooker was mainly in keeping warm operations, and especially the keeping warm operations were most frequent between 18-21 o'clock. Furthermore, it can be seen that cooking operations were performed at 17 and 19 o'clock. Meanwhile, the electricity used during a keeping warm operation and a cooking operation are also illustrated.

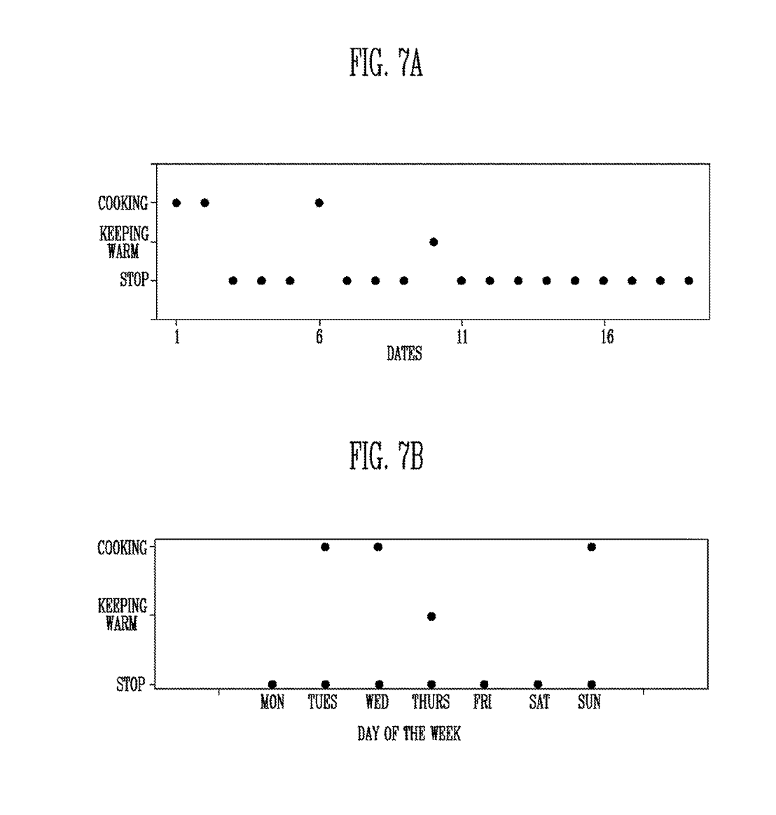

FIGS. 7A and 7B are views illustrating a result of performing electricity usage matching based on a status cluster in a home electronic appliance usage predicting apparatus according to an embodiment of the present disclosure.

More specifically, FIG. 7A illustrates the usage types of actual operations of the electric rice cooker by date, that is, actual operations of stop, keeping warm, and cooking by date. FIG. 7A illustrates operations for day 1 to day 20. More specifically, it can be seen that between day 1 to day 20, operations of cooking rice were performed 3 times, and an operation of keeping warm was performed once. Furthermore, FIG. 7B illustrates operations by day of the week. More specifically, it can be seen that for week 1, a stop operation was performed every day, and an operation of keeping warm was performed only one day on Thursday, and an operation of cooking was performed on Tuesday, Wednesday, and Sunday.

As aforementioned, according to a home electronic appliance usage predicting apparatus and method of the present disclosure, it is possible to understand a status of usage of a home electronic appliance based on the amount of electricity used, and by accumulating such information on the status of usage of the home electronic appliance together with time information, it is possible to analyze a usage pattern of the home electronic appliance and provide the usage pattern to a user so that the user can utilize his/her usage pattern of the home electronic appliance according to a service, and also utilize the usage pattern of the home electronic appliance in perceiving the situation of his/her home. Accordingly, it is possible to analyze data of the amount of electricity usage that may be most easily obtained based on a smart grid or smart home infrastructure that is being established in our daily lives at a rapid pace, and perceive the situation at home while avoiding the difficulty of having to obtain information on legacy home electronic appliances and the problem of compatibility of protocols between different manufacturers of home electronic appliances, and it is also possible to discover the usage pattern of not the user but of each home electronic appliance, so as to develop services for each home electronic appliance or develop services for the home electronic appliances combined according to intended objectives of a service developer.

Herein, it should be understood that each block in the drawings of process flowcharts and combinations thereof may be performed by computer program interactions. These computer program interactions may be mounted onto general purpose computers, special use computers, or other types of processors of programmable data processing equipment, and thus for these interactions to be performed through those computers or other types of processors of programmable data processing equipment, there may be provided means for performing the functions explained in the flowchart block(s). Since those computer program interactions may use computers or other types of computers oriented towards programmable data processing equipment, or may be stored in a computer readable memory in order to realize functions in certain methods, products may be manufactured to contain the means for those interactions performing the functions explained in the flowchart block(s). Since those computer program interactions may be mounted onto computers or other types of programmable data processing equipment, there may be provided a series of operation steps for a process implementable by a computer for performing the functions explained in the flowchart bock(s).

Furthermore, each block may represent a portion of a module, segment, or code that includes one or more implementable interactions for implementing specific logic function(s). Furthermore, it is to be noted that several alternative implementation examples may deviate from the order of functions in the illustrated blocks. For example, two blocks illustrated sequentially may be performed practically at the same time, or they may be performed in reversed order depending on the function that the blocks relate to.

The term ‘˜unit’ used in the present embodiment refers to software or a hardware component such as FPGA or ASIC, and ‘˜unit’ performs certain roles. However, ‘˜unit’ is not limited to software or hardware. The ‘˜unit’ may be configured to exist inside an addressable storage medium or to reproduce one or more processors. Therefore, examples of the ‘˜unit’ include components such as software components, object-oriented software components, class components, and task components, processes, functions, attributes, procedures, subroutines, segments of program codes, drivers, firmware, microcode, circuit, data, database, data structures, tables, arrays, and variables. The functions provided inside components and ‘˜units’ may be combined into a smaller number of components and ‘˜units’, or may be further divided into further components and ‘˜units’. Not only that, the components and ‘˜units’ may be realized to reproduce one or more CPUs inside a device or security multimedia card.

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A network-based home electronic appliance usage predicting apparatus comprising:
an information collecting unit configured to receive electricity usage information of at least one home electronic appliance through a network;
an information database configured to store the electricity usage information received by the information collecting unit; and
a pattern analyzing unit configured to analyze a usage pattern of a corresponding home electronic appliance based on the electricity usage information stored in the information database, generate information on predicted electricity usage of the home electronic appliance based on a result of the analysis, and store the information on predicted electricity usage of the home electronic appliance in the information database.

2. The apparatus according to claim 1,
further comprising a predicted information providing unit configured to output the information on predicted electricity usage of the home electronic appliance stored in the information database.

3. The apparatus according to claim 2,
wherein the predicted information providing unit is a display apparatus.

4. The apparatus according to claim 2,
wherein the predicted information providing unit transmits the information on predicted electricity usage of the home electronic appliance to another apparatus.

5. The apparatus according to claim 4,
wherein the another apparatus to which the information on predicted electricity usage of the home electronic appliance is transmitted comprises at least one of a smart phone, desktop computer, notebook, and tablet connected to the network.

6. The apparatus according to claim 1,
wherein the pattern analyzing unit comprises:
a status clustering module configured to analyze the electricity usage information in a clustering method to generate a status cluster of the home electronic appliance;
an information discretizing module configured to convert the electricity usage information that is continuous to discretized electricity usage information;
an electricity usage matching module configured to compare the discretized electricity usage information with the status cluster of the home electronic appliance generated in the status clustering module, to determine an actual usage status of the home electronic appliance; and
a pattern matching module configured to discover a usage pattern of the home electronic appliance based on data of accumulated results of the determination made by the electricity usage matching module, and convert the discovered usage pattern into data.

7. The apparatus according to claim 6,
wherein the pattern matching module comprises:
a usage variable defined according to characteristics of the home electronic appliance; and
a pattern reference generated based on the usage variable.

8. The apparatus according to claim 7,
wherein the usage variable comprises at least one of a date of usage of the home electronic appliance, frequency of usage of the home electronic appliance, and type of usage of the home electronic appliance.

9. A network-based home electronic appliance usage predicting method comprising:
receiving electricity usage information of at least one home electronic appliance through a network;
storing the received electricity usage information in a database;
analyzing a usage pattern of a corresponding home electronic appliance based on the stored electricity usage information; and
generating information on predicted electricity usage of the home electronic appliance based on a result of the analysis.

10. The method according to claim 9,
further comprising storing the generated information on predicted electricity usage in the database, after the information on predicted electricity usage is generated.

11. The method according to claim 10,
further comprising outputting the information on predicted electricity usage stored in the database.

12. The method according to claim 9,
wherein the analyzing a usage pattern of a corresponding home electronic appliance based on the stored electricity usage information comprises:
analyzing the electricity usage information in a clustering method to generate a status cluster of the home electronic appliance; and
comparing information on actual electricity usage based on the status cluster of the home electronic appliance.
